(19) United States
(12) Patent Application Publication
(10) Pub. No.: US 2021/0034470 A1
(43) Pub. Date: Feb. 4, 2021

(54) DATA PROCESSING DEVICE, DATA PROCESSING METHOD, AND COMPUTER READABLE MEDIUM

(71) Applicant: Mitsubishi Electric Corporation, Tokyo (JP)

(72) Inventors: Yuya ISHIZU, Tokyo (JP); Atsushi HARADA, Tokyo (JP)

(73) Assignee: Mitsubishi Electric Corporation, Tokyo (JP)

(21) Appl. No.: 17/073,759

(22) Filed: Oct. 19, 2020

Related U.S. Application Data
(63) Continuation of application No. PCT/JP2018/022266, filed on Jun. 11, 2018.

(51) Int. Cl. G06F 11/14

(52) U.S. Cl. CPC G06F 11/1448

(57) ABSTRACT

A data processing device (100) is connected to a backup storage (50) used for a backup of data and to a restore test storage (60) used for a restore test on the data backed up. A backup execution section (B-04) stores in the backup storage (50), a plurality of pieces of test divided data selected as restore test targets from among a plurality of pieces of divided data divided from backup-targeted data in a smaller size than a storage size of the restore test storage (60). A restore test execution section (C-05) repeats an operation of storing test divided data from the backup storage (50) into the restore test storage (60) and performs the restore test on the plurality of pieces of test divided data.

### CROSS REFERENCE TO RELATED APPLICATIONS

This application is a Continuation of PCT International Application No. PCT/JP2018/022266, filed on Jun. 11, 2018, which is hereby expressly incorporated by reference into the present application.

### TECHNICAL FIELD

The present invention relates to a restore test.

### BACKGROUND ART

Restore tests are conducted to check whether or not data backed up in advance can be accurately restored in an actual environment for a purpose of ensuring data integrity or an early failure recovery of an information system. In a conventional restore test, the backup data is restored in an environment equivalent to the actual environment, and is tested for whether or not the information system behaves as expected, whether or not consistency of data is kept, and the like. Therefore, the conventional restore test has been based on a premise that sufficient resources such as time and storage capacity can be secured. However, in reality, for a reason of a problem such as cost, in many cases, the resources required to execute the restore test cannot be secured. Thus, the restore test cannot be sufficiently conducted on the backup data that is periodically generated. Particularly, in recent years, a data size handled by the information system has become enormously larger than before because of utilization of a big data analysis or three-dimensional spatiotemporal information in IoT (Internet of Things) services and the like. Therefore, it is considered that a tendency of insufficiency in the resources for the restore test remarkably grows.

Due to the background described above, it is necessary to realize a restore test using a storage for a restore test with a limited size.

In Patent Literature 1, for a purpose of reducing time required for a backup process and a restore process, data is divided according to a type of data at a time of the backup process. Further, in Patent Literature 1, the backup and restore targets are limited to only pieces of necessary data among pieces of data after division.

### CITATION LIST

### Patent Literature

Patent Literature 1: JP2008-171241A

### SUMMARY OF INVENTION

### Technical Problem

The technique of Patent Literature 1 has a problem that a restore test-purpose storage having a storage size equivalent to a total size of the pieces of data to be backed up and restored (the pieces of data after division) is required.

One of the main objects of the present invention is to solve the problem described above. More specifically, the present invention mainly aims to make a restore test executable even with a restore test storage having a limited storage size.

### Solution to Problem

A data processing device according to the present invention, connected to a backup storage used for a backup of data and to a restore test storage used for a restore test on the data backed up, includes:

a backup execution section to store in the backup storage, a plurality of pieces of test divided data selected as restore test targets from among a plurality of pieces of divided data divided from backup-targeted data in a smaller size than a storage size of the restore test storage; and

a restore test execution section to repeat an operation of storing test divided data from the backup storage into the restore test storage and perform the restore test on the plurality of pieces of test divided data.

### Advantageous Effects of Invention

According to the present invention, it is possible to execute a restore test even with a restore test storage having a limited storage size.

### BRIEF DESCRIPTION OF DRAWINGS

FIG. 1 is a diagram illustrating a configuration example of a restore test execution system according to a first embodiment;

FIG. 2 is a diagram illustrating a functional configuration example of the restore test execution system according to the first embodiment;

FIG. 3 is a flowchart illustrating an inter-data relation estimation process according to the first embodiment;

FIG. 4 is a diagram illustrating an example of the inter-data relation estimation result information according to the first embodiment;

FIG. 5 is a flowchart illustrating a backup process according to the first embodiment;

FIG. 6 is a diagram illustrating an example of an inter-data relation estimation result according to the first embodiment;

FIG. 7 is a diagram illustrating an example of inter-data relation information according to the first embodiment;

FIG. 8 is a diagram illustrating an example of a division pattern according to the first embodiment;

FIG. 9 is a flowchart illustrating a restore test process according to the first embodiment;

FIG. 10 is a diagram illustrating an example of restore test parameter information according to the first embodiment;

FIG. 11 is a diagram illustrating an example of test item list information according to the first embodiment;

FIG. 12 is a diagram illustrating an example of a restore test plan generation result according to the first embodiment;

FIG. 13 is a diagram illustrating an example of restore test execution result information according to the first embodiment;

FIG. 14 is a diagram illustrating a hardware configuration example of an inter-data relation estimation device according to the first embodiment;

FIG. 15 is a diagram illustrating a hardware configuration example of a backup device according to the first embodiment; and

FIG. 16 is a diagram illustrating a hardware configuration example of a restore test device according to the first embodiment.

### DESCRIPTION OF EMBODIMENTS

Hereinafter, embodiments of the present invention will be described with reference to the drawings. In the following description of the embodiments and the drawings, the same reference numerals indicate the same or corresponding parts.

### First Embodiment

### Description of Configuration

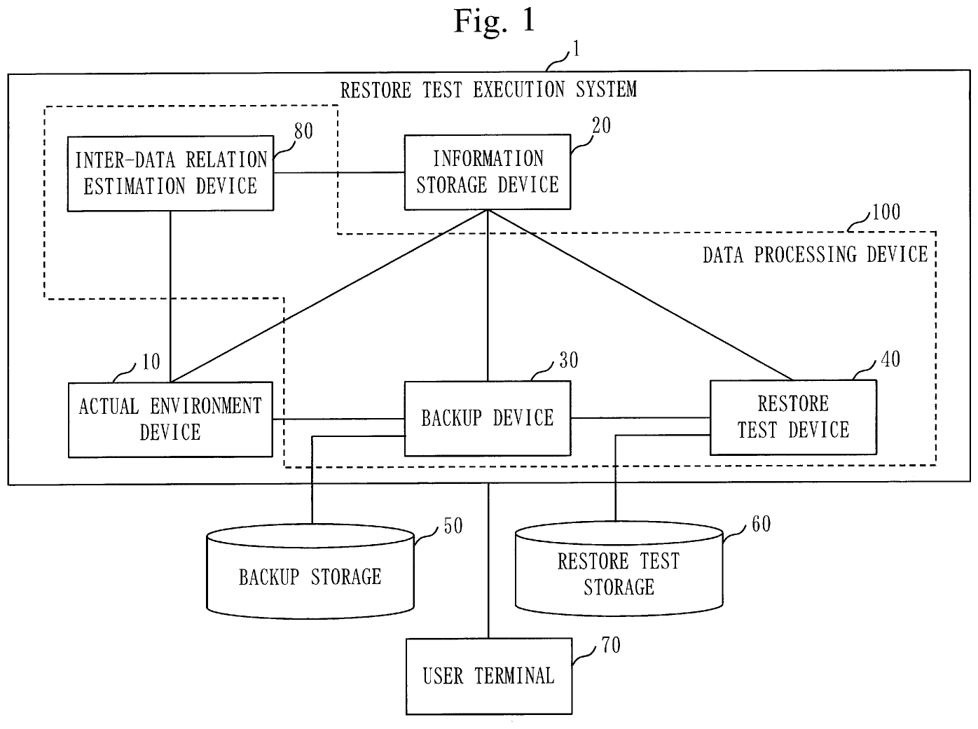

FIG. 1 illustrates a configuration example of a restore test execution system 1 according to the present embodiment.

The restore test execution system 1 according to the present embodiment includes an actual environment device 10, an information storage device 20, a backup device 30, a restore test device 40, and an inter-data relation estimation device 80.

The restore test execution system 1 is connected to a user terminal 70.

Further, the backup device 30 is connected to a backup storage 50, and the restore test device 40 is connected to a restore test storage 60.

In the present embodiment, the backup-targeted data is divided into a plurality of pieces of data (hereinafter, referred to as divided data) having a smaller size than a storage size of the restore test storage 60. The restore test storage 60 is a storage used for a restore test. Among pieces of divided data, a plurality of pieces of divided data selected as restore test targets (hereinafter, referred to as test divided data) are stored in the backup storage 50. The backup storage 50 is a storage for a backup. Then, when the restore test is performed, the test divided data is sequentially stored from the backup storage 50 into the restore test storage 60. That is, by repeating an operation of storing the test divided data from the backup storage 50 into the restore test storage 60, it is possible to execute the restore test on a plurality of pieces of test divided data with the restore test storage 60 having a limited size.

Further, in the present embodiment, relation information indicating a relation between the pieces of divided data is held. Parameters used for the restore test can be calculated using the relation information. Also, by designating a specific parameter by a user, it is possible to recalculate the other parameters. Thereby, in the present embodiment, it is possible to formulate a restore test execution plan that reflects the amount of resources that the user can prepare.

Components of the restore test execution system 1 illustrated in FIG. 1 will be described below.

The actual environment device 10 operates in an actual environment. That is, the actual environment device 10 performs data processing using the backup-targeted data.

The information storage device 20 stores the relation information between the pieces of divided data, information regarding the divided data, information regarding the restore test, and the like.

The backup device 30 performs the backup of the test divided data.

More specifically, the backup device 30 stores in the backup storage 50, the plurality of pieces of divided data selected by the user as restore test targets (the test divided data) from among the plurality of pieces of divided data.

The restore test device 40 generates a restore test plan according to an instruction of the user, and executes the restore test.

More specifically, the restore test device 40 sequentially stores the test divided data from the backup storage 50 into the restore test storage 60, and performs the restore test on the plurality of pieces of divided data.

The backup storage 50 is used for the backup of data. More specifically, the backup storage 50 stores the test divided data.

The restore test storage 60 is used for the restore test on backed-up data. More specifically, the restore test storage 60 temporarily stores the test divided data for the restore test.

The user terminal 70 is a terminal device operated by the user of the restore test execution system 1. The user terminal 70 transmits and receives information between the backup device 30 and the restore test device 40.

The inter-data relation estimation device 80 estimates a relation between the pieces of divided data.

A combination of the backup device 30, the restore test device 40, and the inter-data relation estimation device 80 illustrated in FIG. 1 is referred to as a data processing device 100. Further, the operations performed by the backup device 30, the restore test device 40, and the inter-data relation estimation device 80 correspond to a data processing method and a data processing program.

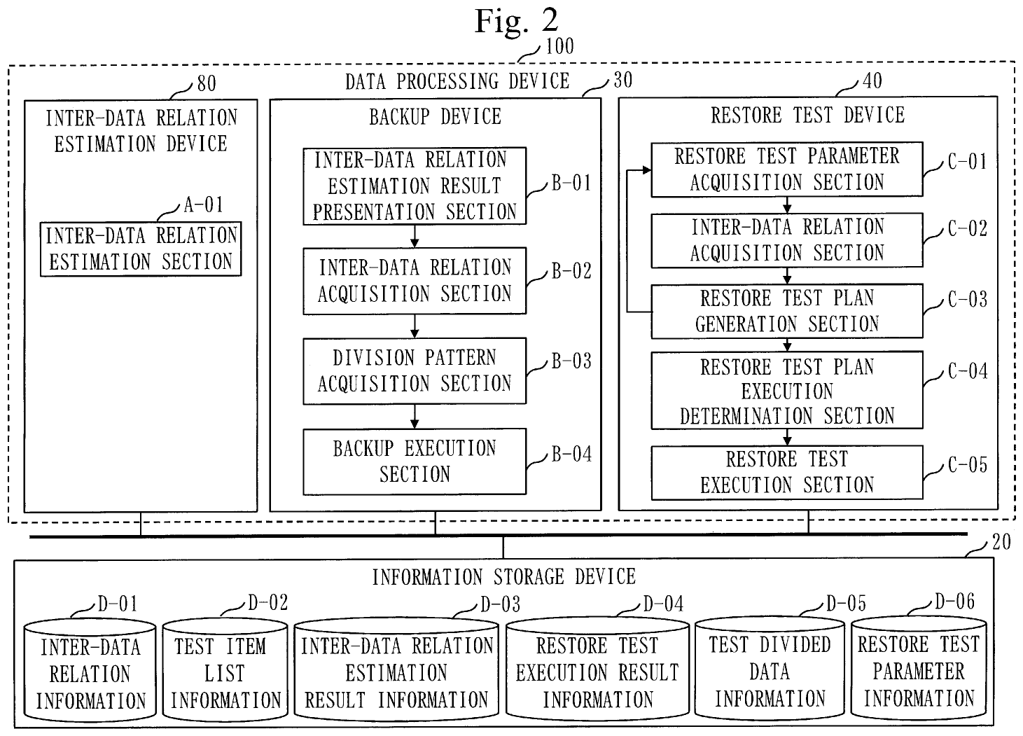

FIG. 2 illustrates a functional configuration example of the restore test execution system 1 according to the present embodiment. More specifically, FIG. 2 illustrates functional configuration examples of the inter-data relation estimation device 80, the backup device 30, and the restore test device 40. Further, FIG. 2 illustrates examples of pieces of information stored in the information storage device 20.

In the inter-data relation estimation device 80, an inter-data relation estimation section A-01 estimates the relation between the pieces of divided data. While the actual environment device 10 is operating, the inter-data relation estimation section A-01 monitors a usage status of the pieces of divided data in the actual environment device 10, and estimates the relation between the pieces of divided data. The estimation result of the inter-data relation estimation section A-01 is stored in the information storage device 20 as inter-data relation estimation result information D-03.

The divided data which is subject to an estimation may be a file having a directory structure or table data of a relational database.

The inter-data relation estimation section A-01 statistically measures reference destinations or reference frequencies of the pieces of divided data referred to during the process for each function of the actual environment device 10, and estimates the relation between the pieces of divided data. Besides, the inter-data relation estimation section A-01 may support a plurality of estimation methods.

In the backup device 30, an inter-data relation estimation result presentation section B-01 acquires the inter-data relation estimation result information D-03 from the information storage device 20. Then, the inter-data relation estimation result presentation section B-01 transmits the acquired inter-data relation estimation result information D-03 to the user terminal 70. That is, the inter-data relation estimation result presentation section B-01 presents the estimation result of the inter-data relation estimation section A-01 to the user.

Note that the inter-data relation estimation result presentation section B-01 can be omitted.

An inter-data relation acquisition section B-02 receives from the user terminal 70, information indicating the relation between the pieces of divided data designated by the user. The inter-data relation acquisition section B-02 stores in the information storage device 20, the received information as inter-data relation information D-01.

Note that the inter-data relation acquisition section B-02 can be omitted.

A division pattern acquisition section B-03 receives a division pattern from the user terminal 70.

In the division pattern, the divided data which is subject to the restore test, that is, the test divided data is designated. In the division pattern, as a method for designating the test divided data, for example, the test divided data is designated by a unit of a function. Further, the test divided data may be designated by a unit of a time division. Further, the designation by the unit of the function and the designation by the unit of the time division may be combined.

The division pattern acquisition section B-03 stores in the information storage device 20, the division pattern received from the user terminal 70 as test divided data information D-05.

A backup execution section B-04 stores in the backup storage 50, the plurality of pieces of test divided data selected by the user, based on the test divided data information D-05.

A process performed by the backup execution section B-04 corresponds to a backup execution process.

In the restore test device 40, a restore test parameter acquisition section C-01 acquires restore a test parameter from the user terminal 70. The restore test parameter is, for example, a restore test execution time condition and a test coverage condition.

The restore test parameter acquisition section C-01 stores in the information storage device 20, the acquired restore test parameters as restore test parameter information D-06.

An inter-data relation acquisition section C-02 acquires the inter-data relation information D-01 from the information storage device 20.

A restore test plan generation section C-03 generates a restore test plan for the plurality of pieces of test divided data.

The restore test plan generation section C-03 acquires the restore test parameter information D-06 and test item list information D-02 from the information storage device 20. Then, the restore test plan generation section C-03 selects a restore test pattern satisfying the test execution time condition and the test coverage condition from among the plurality of restore test patterns indicated in the test item list information D-02, based on the test execution time condition, the test coverage condition, a size of each test divided data, and a storage size of the restore test storage 60 indicated in the restore test parameter information D-06. Then, the restore test plan generation section C-03 notifies a restore test plan execution determination section C-04 of the selected restore test pattern as the restore test plan.

The restore test plan execution determination section C-04 transmits to the user terminal 70, the restore test plan notified from the restore test plan generation section C-03.

In addition, the restore test plan execution determination section C-04 acquires an instruction of the user for the restore test plan from the user terminal 70.

When the user instructs to execute the restore test, the restore test plan execution determination section C-04 notifies a restore test execution section C-05 of an execution of the restore test plan. On the other hand, if the user does not instruct to execute the restore test, the restore test plan execution determination section C-04 instructs the restore test parameter acquisition section C-01 to acquire new restore a test parameter from the user.

The restore test execution section C-05 executes the restore test according to the restore test plan notified from the restore test plan execution determination section C-04.

More specifically, the restore test execution section C-05 repeats an operation of storing the test divided data from the backup storage 50 into the restore test storage 60 to perform the restore test on the plurality of pieces of test divided data.

When the restore test is completed, the restore test execution section C-05 stores in the information storage device 20, an execution result of the restore test as restore test execution result information D-04.

A process performed by the restore test execution section C-05 corresponds to a restore test execution process.

In the information storage device 20, the inter-data relation information D-01 indicates the relation between the pieces of divided data, as described above. The inter-data relation information D-01 indicates, for example, a parent-child relation in a directory of a file system, a relation of a database table, a function, divided data referred to by the function, and the like.

The test item list information D-02 indicates information regarding each test item of the restore test.

Test items are prepared by an arbitrary unit such as a unit of a system function. Each test item includes, for example, a test execution method, test coverage, execution time, and test-targeted data.

It is assumed that the test item list information D-02 is stored in the information storage device 20 by an arbitrary method before a restore test plan generation process is executed by the restore test plan generation section C-03.

As described above, the inter-data relation estimation result information D-03 indicates the relation designated by the user between the pieces of divided data. The inter-data relation estimation result information D-03 indicates, for example, the parent-child relation in a directory of a file system, a relation of a database table, a function, divided data referred to by the function and the like.

The restore test execution result information D-04 indicates the execution result of the restore test.

For example, the restore test execution result information D-04 indicates a start date and time of the restore test, a test divided data name, the test coverage, the storage size of the restore test storage 60, and the execution time of the restore test. Information other than these may be included in the restore test execution result information D-04.

The test divided data information D-05 indicates information regarding the test divided data.

For example, the test divided data information D-05 indicates a data name of the test divided data, a data path of the test divided data, and a data size of the test divided data.

The restore test parameter information D-06 illustrates parameters regarding the restore test plan.

For example, the restore test parameter information D-06 indicates the data name of the test divided data, the storage size of the restore test storage, the execution time condition, and the test coverage condition.

### Description of Operation

Next, an operation example of the restore test execution system 1 according to the present embodiment will be described.

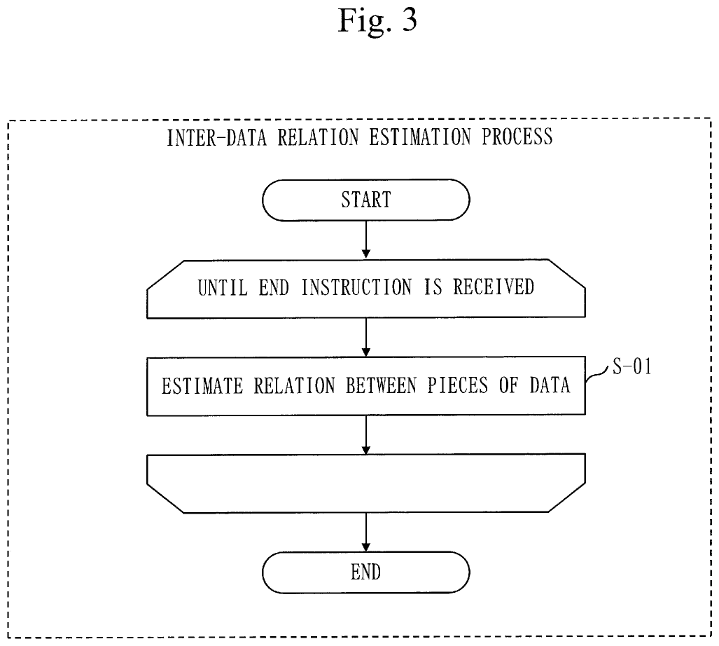

FIG. 3 illustrates an inter-data relation estimation process.

In the inter-data relation estimation process, the inter-data relation estimation section A-01 estimates the relation between the pieces of divided data in step S-01 until an end instruction is received from the user terminal 70.

Then, the inter-data relation estimation section A-01 stores in the information storage device 20, the estimation result as the inter-data relation estimation result information D-03.

For example, it is acceptable that a program for monitoring a status of access to the pieces of divided data of the actual environment device 10 is stationed in the actual environment device 10 and the inter-data relation estimation section A-01 estimates the relation between the pieces of divided data based on a monitoring result of the program. Also, it is acceptable that a program for monitoring an occurrence status of queries to an RDB (Relational Database) of the actual environment device 10 is stationed in the actual environment device 10 and the inter-data relation estimation section A-01 estimates the relation between the pieces of divided data based on a monitoring result of the program. Also, it is acceptable that by using a function provided by an RDBMS (Relational Database Management System), the inter-data relation estimation section A-01 estimates the relation between the pieces of divided data.

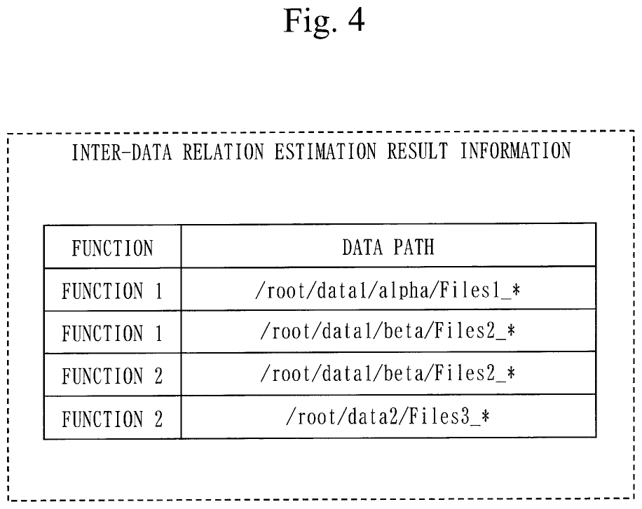

FIG. 4 illustrates an example of the inter-data relation estimation result information D-03.

In the example of FIG. 4, the relation between the pieces of divided data is estimated by a “unit of a function”. Further, in the example of FIG. 4, the divided data is a file having a directory structure.

The example of FIG. 4 indicates that/root/data1/alpha/Files1_* and /root/data1/beta/Files2_* are required for function 1 to operate. In addition, the example of FIG. 4 indicates that/root/data1/beta/Files2_* and/root/data2/Files3_* are required for the function 2 to operate.

Here, “*” indicates a wild card, which means that an arbitrary character string having a length of 0 or more characters can be included. In this way, a regular expression can also be used for the divided data.

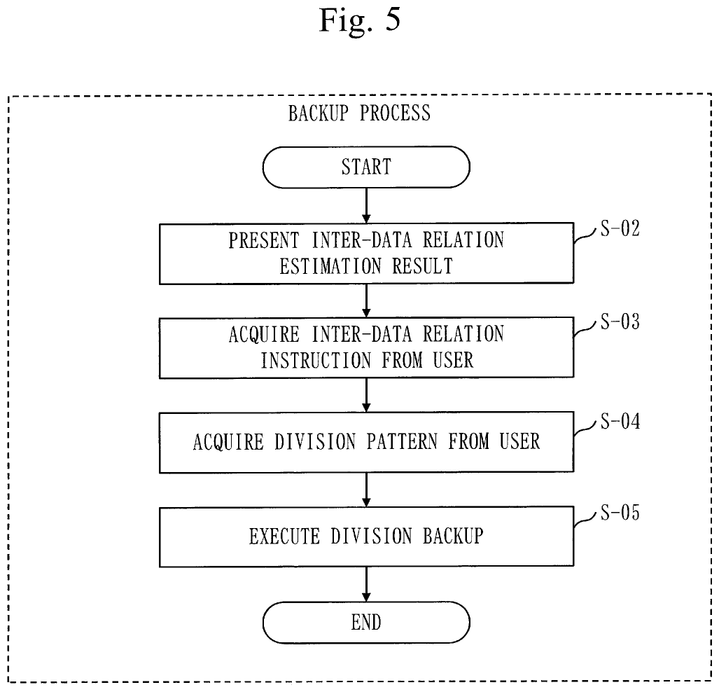

FIG. 5 illustrates a backup process.

In the backup process, the backup device 30 presents the inter-data relation estimation result information D-03 to the user, acquires the selection result of the test divided data from the user, and stores the test divided data in the backup storage 50.

In the backup process, the backup device 30 specifically performs following processes.

In step S-02, the inter-data relation estimation result presentation section B-01 acquires the inter-data relation estimation result information D-03 from the information storage device 20, and presents the inter-data relation estimation result information D-03 to the user. That is, the inter-data relation estimation result presentation section B-01 transmits the inter-data relation estimation result information D-03 to the user terminal 70, and causes the user terminal 70 to display the inter-data relation estimation result information D-03.

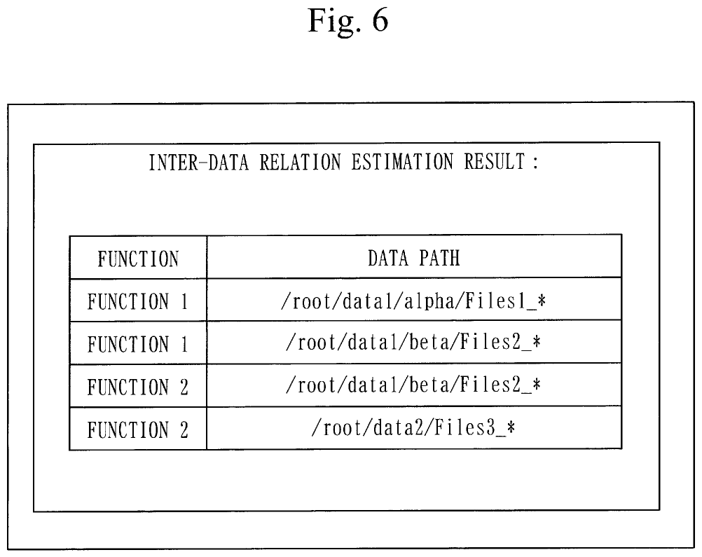

For example, the inter-data relation estimation result information D-03 is displayed on the user terminal 70 as illustrated in FIG. 6.

Next, in step S-03, the inter-data relation acquisition section B-02 acquires an inter-data relation instruction from the user. The inter-data relation acquisition section B-02 stores in the information storage device 20, the acquired inter-data relation instruction as the inter-data relation information D-01.

The user can designate the relation between the pieces of divided data recognized by the user, by using the user terminal 70, with reference to the inter-data relation estimation result information D-03 exemplified in FIG. 6. Then, the user terminal 70 transmits to the inter-data relation acquisition section B-02, the relation between the pieces of divided data designated by the user as the inter-data relation instruction.

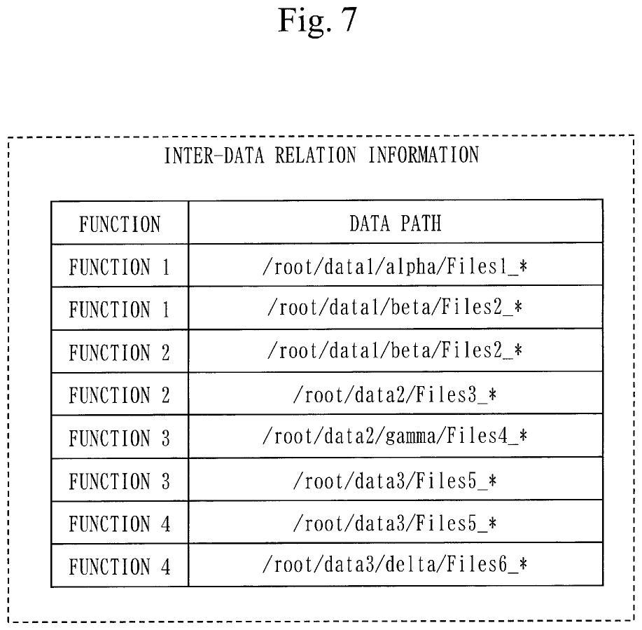

For example, the inter-data relation acquisition section B-02 stores the inter-data relation information D-01 illustrated in FIG. 7 in the information storage device 20.

In the example of FIG. 7, as compared with the estimation result of the relation between the pieces of data illustrated in FIGS. 6 and 4, rows for a function 3 and a function 4 are added.

In the example of FIG. 7, a description is added by the user that /root/data1/gamma/Files4_* and/root/data3/Files5_* are required for the function 3 to operate. Further, a description is added that/root/data3/Files5_* and /root/data3/delta/Files6_* are required for the function 4 to operate.

That is, the inter-data relation estimation result presentation section B-01 estimates only the relations regarding the function 1 and the function 2, but the relations regarding the function 3 and the function 4 are added by the user.

Besides, in the example of FIG. 7, /root/data1/beta/Files2_* is commonly required for the function 1 and the function 2, and/root/data3/Files5_* is commonly required for the function 3 and the function 4.

Note that step S-03 can be omitted.

Next, in step S-04, the division pattern acquisition section B-03 acquires the division pattern from the user. More specifically, the division pattern acquisition section B-03 receives the division pattern from the user terminal 70.

Then, the division pattern acquisition section B-03 stores in the information storage device 20, the acquired division pattern as the test divided data information D-05.

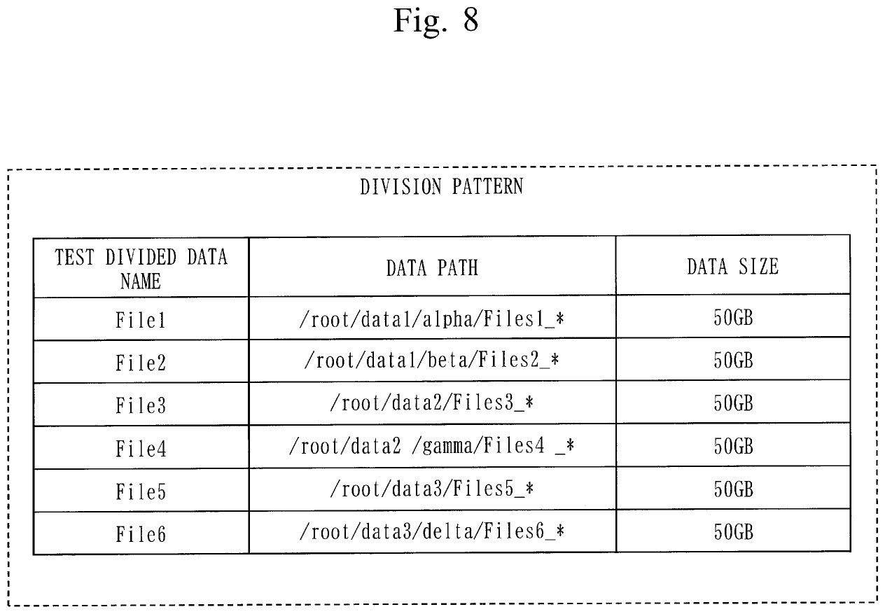

The division pattern acquisition section B-03 acquires, for example, a division pattern illustrated in FIG. 8.

FIG. 8 illustrates that six pieces of divided data of File1 to File6 are selected as the pieces of test divided data. Although a test divided data name, a data path, and a data size are illustrated in FIG. 8, the data size can be omitted. Further, the test divided data can be specified as long as there is any one of the test divided data name and the data path. Thus, it is sufficient if at least one of the test divided data name and the data path is indicated in the division pattern.

The test divided data information D-05 may be generated in advance. In this case, step S-04 can be omitted.

In the example of FIG. 8, the pieces of test divided data are specified by a unit of a data path on the directory. However, the test divided data may be specified by a unit of a function or specified by a unit of a time.

Next, in step S-05, the backup execution section B-04 stores the test divided data in the backup storage 50 with reference to the test divided data information D-05.

For example, the backup execution section B-04 stores in the backup storage 50, data of a file path being/root/data1/alpha/Files1_* under a name of File1 according to the division pattern (test divided data information D-05) illustrated in FIG. 8. Further, the backup execution section B-04 stores in the backup storage 50, data of a file path being/root/data1/beta/Files2_* under a name of File2. Further, the backup execution section B-04 stores in the backup storage 50, data of a file path being /root/data2/Files3_* under a name of File3. Further, the backup execution section B-04 stores in the backup storage 50, data of a file path being /root/data2/gamma/Files4_* under a name of File4. Further, the backup execution section B-04 stores in the backup storage 50, data of a file path being /root/data3/Files5_* under a name of File5. Further, the backup execution section B-04 stores in the backup storage 50, data of a file path being root/data1/delta/Files6_* under a name of File6. By doing this, the backup execution section B-04 backs up the plurality of pieces of test divided data.

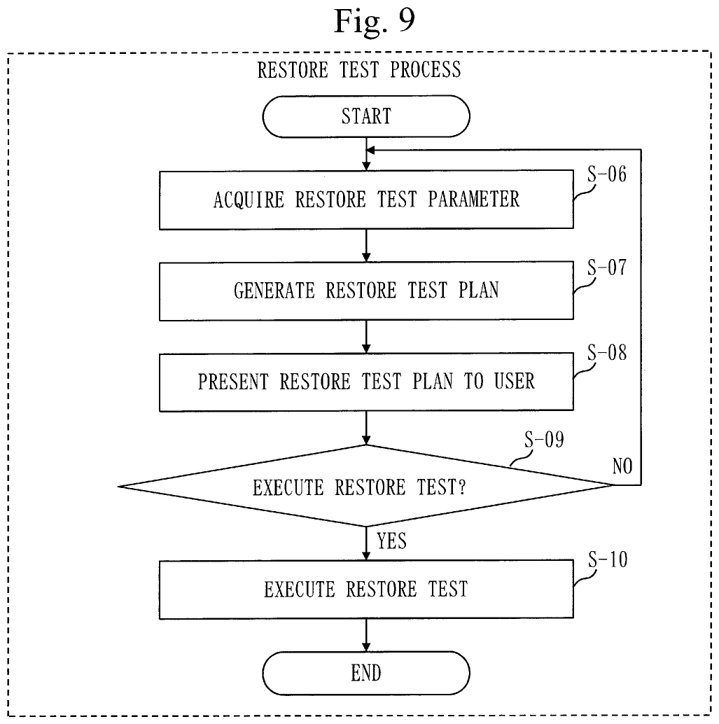

FIG. 9 illustrates a restore test process.

In the restore test process, the restore test device 40 acquires the restore test parameter, generates the restore test plan, and executes the restore test.

In the restore test process, the restore test device 40 specifically performs following processes.

In step S-06, the restore test parameter acquisition section C-01 acquires the restore test parameter from the user terminal 70. Then, the restore test parameter acquisition section C-01 stores in the information storage device 20, the acquired restore test parameter as the restore test parameter information D-06.

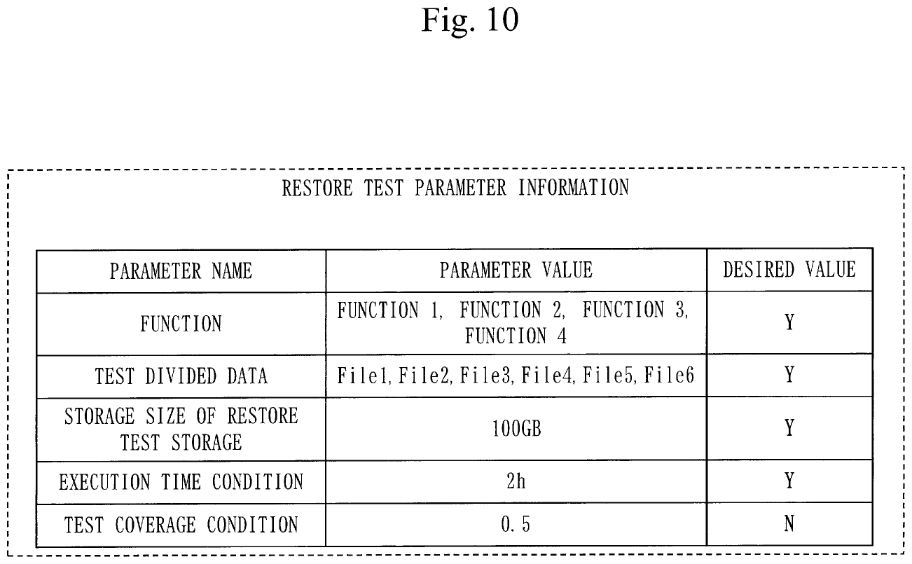

The restore test parameter acquisition section C-01 stores, for example, the restore test parameter information D-06 illustrated in FIG. 10 in the information storage device 20.

The example of FIG. 10 illustrates the function 1, the function 2, the function 3, and the function 4 as the functions subject to the restore test. Further, the example of FIG. 10 illustrates File1, File2, File3, File4, File5 and File6 as the pieces of test divided data. Further, the example of FIG. 10 illustrates that a storage size of the restore test storage 60 is 100 GB. Further, FIG. 10 illustrates that the execution time condition of the restore test is 2 hours. Further, the example of FIG. 10 illustrates that the test coverage condition of the restore test is 0.5. Note that the storage size of the restore test storage can be omitted, and either the test divided data or the function can be omitted, among the items illustrated in FIG. 10.

Further, in FIG. 10, it is indicated that an item whose desired value column is “Y” is an essential condition. On the other hand, it is indicated that an item whose desired value column is “N” is not an essential condition. That is, in the example of FIG. 10, for the function 1, the function 2, the function 3, and the function 4, it is necessary to decide a value of the test coverage at which the restore test on the pieces of test divided data of File1, File2, File3, File4, File5, and File6 using the restore test storage 60 having the storage size of 100 GB is completed within two hours. The test coverage takes a value from 0 to 1. The closer it is to 1, the higher the coverage is, and the closer it is to 0, the lower the coverage is.

In addition to those illustrated in FIG. 10, a threshold value of a priority degree given to each of the pieces of test divided data, a range of the test divided data, and the like can be designated as a parameter.

In step S-07, the restore test plan generation section C-03 generates the restore test plan.

More specifically, the inter-data relation acquisition section C-02 reads the inter-data relation information D-01 from the information storage device 20.

Next, the restore test plan generation section C-03 generates a restore test plan in consideration of the relation between the pieces of divided data and the storage size for the restore test in the restore test parameter information D-06.

For example, in the restore test parameter information D-06 illustrated in FIG. 10, a storage size of the restore test storage 60 is 100 GB. Further, according to the test divided data information D-05 in FIG. 8, the data size of all the test divided data is 50 GB. Therefore, two pieces of test divided data can be stored in the restore test storage 60.

In the generation of the restore test plan, first, the restore test plan generation section C-03 specifies a function subject to the restore test. The restore test plan generation section C-03 specifies the functions 1 to 4 as functions subject to the restore test according to the restore test parameter information D-06 in FIG. 10.

When a description of the test divided data is omitted in the restore test parameter information D-06, the test divided data is specified by following Procedure (1) and Procedure (2). When the test divided data is described in the restore test parameter information D-06, the following procedure (1) and procedure (2) are unnecessary.

Procedure (1)

The restore test plan generation section C-03 specifies the test divided data used for the restore test on each of the functions. According to the inter-data relation information D-01 in FIG. 7, the restore test plan generation section C-03 specifies that /root/data1/alpha/Files1_* and/root/data1/beta/Files2_*, /root/data1/beta/Files2_* and /root/data2/Files3_*, /root/data2/gamma/Files4_* and/root/data3/Files5_*, and /root/data3/Files5_* and/root/data1/delta/Files6_* are used.

Procedure (2)

The restore test plan generation section C-03 refers to the test divided data information D-05 in FIG. 8 to specify data names of the pieces of divided data specified in Procedure (1). Specifically, the restore test plan generation section C-03 specifies that the data name of/root/data1/alpha/Files1_* is File1. Further, the restore test plan generation section C-03 specifies that the data name of/root/data1/beta/Files2_* is File2. Further, the restore test plan generation section C-03 specifies that the data name of/root/data2/Files3_* is File3. Further, the restore test plan generation section C-03 specifies that the data name of/root/data2/gamma/Files4_* is File4. Further, the restore test plan generation section C-03 specifies that the data name of /root/data3/Files5_* is File5. Further, the restore test plan generation section C-03 specifies that the data name of root/data3/delta/Files6_* is File6.

Next, the restore test plan generation section C-03 generates restore test plan for the function 1 to the function 4. Specifically, the restore test plan generation section C-03 generates the restore test plan in a following manner.

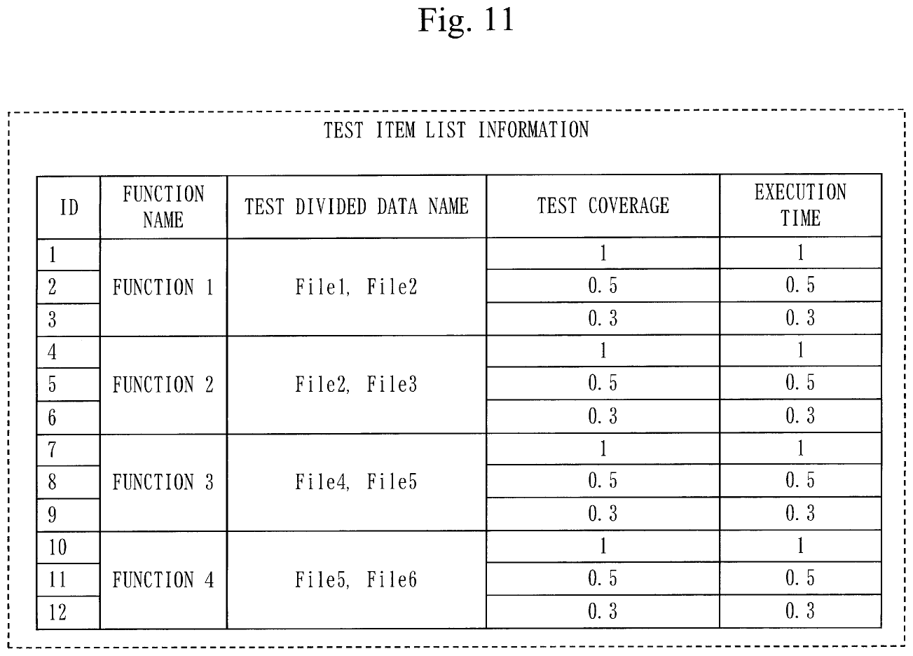

First, the restore test plan generation section C-03 reads the test item list information D-02 in FIG. 11 from the information storage device 20.

The test item list information D-02 indicates the functions subject to the restore test. Further, the test item list information D-02 indicates the test divided data name for each function. Further, the test item list information D-02 indicates for each function, representative values of the test coverage (“1”, “0.5”, and “0.3” in FIG. 11) and a predicted value of the execution time of the restore test for each of the representative values. Each of rows illustrated in the test item list information D-02 is referred to as a restore test pattern.

The restore test plan generation section C-03 extracts from the test item list information D-02, combinations of restore test patterns satisfying a condition (1) “a total of the execution time does not exceed 2 hours” and a condition (2) “a total size of the pieces of test divided data stored in the restore test storage 60 does not exceed 100 GB”. Note that an item whose desired value column is “N” in the in the restore test parameter information D-06 in FIG. 10 does not need to satisfy the conditions. In the example of FIG. 10, since the desired value column of the test coverage is “N”, the restore test plan generation section C-03 extracts the combinations of the restore test patterns satisfying the above conditions (1) and (2) including a restore test pattern whose test coverage is “0.3” in the test item list information D-02 in FIG. 11. Then, the restore test plan generation section C-03 selects from among the extracted combinations, a combination of restore test patterns satisfying the desired value of the test coverage. Specifically, the restore test plan generation section C-03 selects for the function 1, a row of ID: 2 in the test item list information D-02 in FIG. 11. Further, the restore test plan generation section C-03 selects a row of ID: 5 for the function 2. Further, the restore test plan generation section C-03 selects a row of ID: 8 for the function 3. Further, the restore test plan generation section C-03 selects a row of ID: 11 for the function 4.

When selected in this way, the total of the execution time is 2 hours, and the test coverage is (0.5+0.5+0.5+0.5)/4=0.5.

Besides, a method of calculating the test coverage is not limited to the above, and the restore test plan generation section C-03 may calculate the test coverage by weighting each function or each test divided data.

Here, when there exists no combination satisfying both the condition (1) and the condition (2), the restore test plan generation section C-03 transmits to the user terminal 70, a message that the restore test plan cannot be generated. Then, the restore test plan generation section C-03 returns to step S-06 and acquires a new restore test parameter from the user terminal 70.

Besides, in the above, the restore test plan generation section C-03 extracts the combinations satisfying the condition (1) and the condition (2) by a brute force method. However, the restore test plan generation section C-03 may extracts the combinations satisfying the condition (1) and the condition (2) by another method.

Further, in the above, the restore test plan generation section C-03 selects one combination from among the extracted combinations. However, the restore test plan generation section C-03 may select a plurality of combinations from among the extracted combinations. Further, the restore test plan generation section C-03 may select all of the extracted combinations.

In step S-08, the restore test plan execution determination section C-04 presents to the user, the combination of the restore test patterns selected by the restore test plan generation section C-03 as the restore test plan. That is, the restore test plan generation section C-03 transmits to the user terminal 70, a message indicating the selected combination of the restore test patterns.

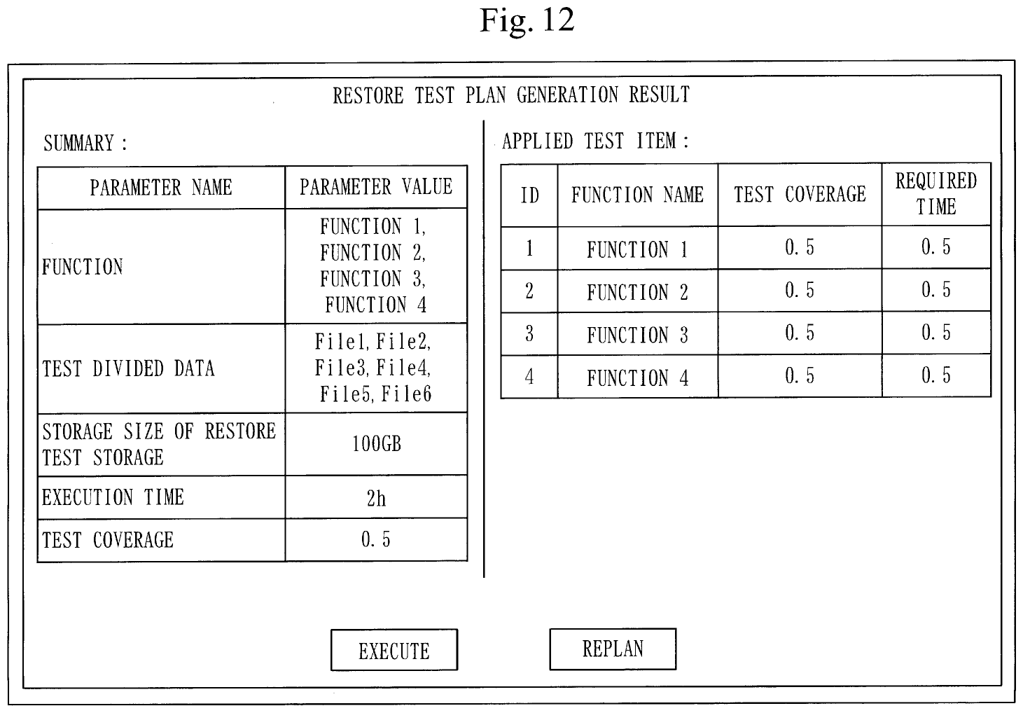

The restore test plan is displayed on the user terminal 70, for example, as illustrated in FIG. 12.

In step S-09, the restore test plan execution determination section C-04 determines whether or not the restore test is executed.

More specifically, the restore test plan execution determination section C-04 receives the instruction of the user from the user terminal 70.

When the user presses down on a “execute” button on a screen of the restore test plan generation result illustrated in FIG. 12, a restore test execution instruction is transmitted from the user terminal 70. When the restore test plan execution determination section C-04 receives the restore test execution instruction from the user terminal 70, step S-10 is performed. On the other hand, when the user presses down on a “replan” button on the screen of the restore test plan generation result illustrated in FIG. 12, a restore test replan instruction is transmitted from the user terminal 70. When the restore test plan execution determination section C-04 receives the restore test replan instruction from the user terminal 70, step S-06 is performed.

In step S-10, the restore test execution section C-05 executes the restore test according to the restore test plan.

More specifically, the restore test execution section C-05 repeats the operation of storing the test divided data from the backup storage 50 into the restore test storage 60 according to the restore test plan, and performs the restore test on the plurality of pieces of test divided data.

After the restore test is completed, the restore test execution section C-05 stores in the information storage device 20, the execution result of the restore test as the restore test execution result information D-04.

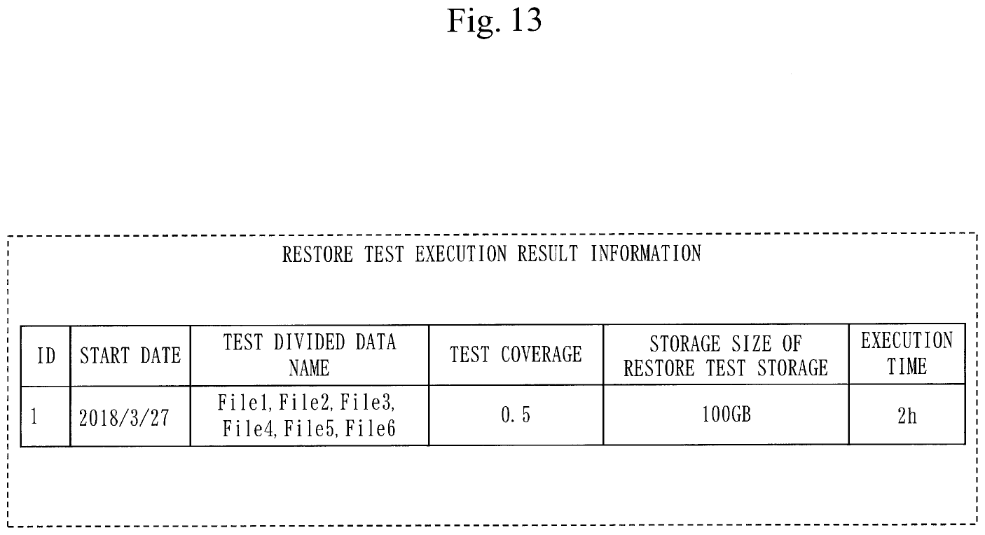

FIG. 13 illustrates an example of the restore test execution result information D-04. In the example of FIG. 13, items of ID, start date and time, a test divided data name, test coverage, a storage size of the restore test storage, and execution time are held. FIG. 13 illustrates an execution result when there is no problem with all the executed restore tests. The items included in the restore test execution result information D-04 are not limited to those illustrated in FIG. 13.

Further, a series of operations, execution details, and execution order in steps S-01 to S-10 are merely examples, and are not necessarily limited to the above.

### Description of Effect of Embodiment

As described above, according to the present embodiment, it is possible to execute the restore test by repeating the operation of storing in the restore test storage, the pieces of divided data divided in the smaller size than the storage size of the restore test storage even when the size of the restore test storage is insufficient for the size of the backup-targeted data.

Therefore, according to the present embodiment, it is possible to implement a plan and an execution of a restore test using a restore test storage with a small-capacity. Further, according to the present embodiment, it is possible to reduce a storage cost for executing the restore test.

Further, according to the present embodiment, it is possible to implement the plan and the execution of the restore test by setting to values intended by a user, interdependent parameters (execution time, test coverage, and the like) including a limited storage size of a restore test storage.

Further, according to the present embodiment, it is possible to help the user to understand a configuration of backup-targeted data and effectively plan the restore test by presenting to the user at a time of backup, estimation information on a relation between pieces of divided data.

### Description of Hardware Configuration

Finally, hardware configurations of the inter-data relation estimation device 80, the backup device 30, and the restore test device 40 will be described.

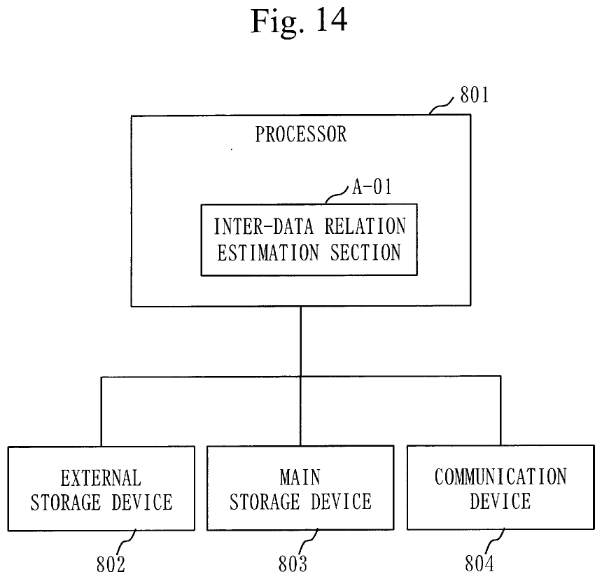

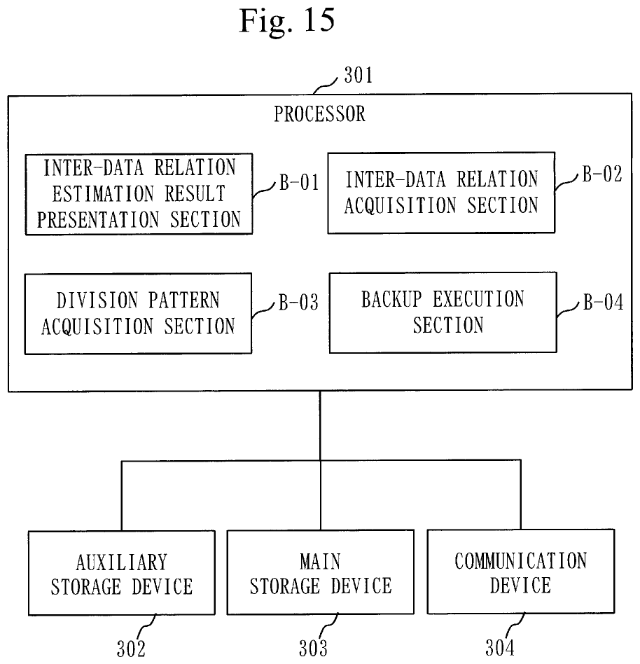

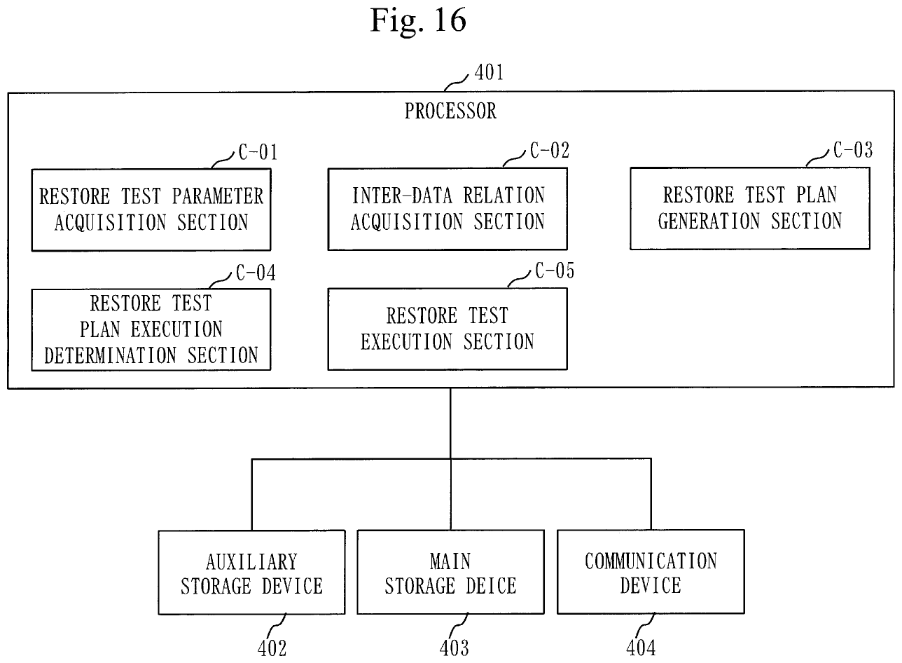

FIG. 14 illustrates a hardware configuration example of the inter-data relation estimation device 80. FIG. 15 illustrates a hardware configuration example of the backup device 30. FIG. 16 illustrates a hardware configuration example of the restore test device 40.

The inter-data relation estimation device 80 according to the present embodiment is a computer.

The inter-data relation estimation device 80 includes a processor 801, an external storage device 802, a main storage device 803, and a communication device 804 as hardware.

The external storage device 802 stores a program that implements a function of the inter-data relation estimation section A-01.

The program that implements the function of the inter-data relation estimation section A-01 is loaded from the external storage device 802 into the main storage device 803, and is executed by the processor 801.

FIG. 14 schematically illustrates a state in which the processor 801 executes the program that implements the function of the inter-data relation estimation section A-01.

The processor 801 is an IC (Integrated Circuit) that performs processing.

The processor 801 is, for example, a CPU (Central Processing Unit) or a DSP (Digital Signal Processor).

The external storage device 802 is, for example, a ROM (Read Only Memory), a flash memory, or an HDD (Hard Disk Drive).

The main storage device 803 is, for example, a RAM (Random Access Memory).

The communication device 804 illustrated in FIG. 14 is an electronic circuit that executes a data communication process.

The communication device 804 is, for example, a communication chip or an NIC (Network Interface Card).

An OS (Operating System) is also stored in the external storage device 802.

In addition, at least a part of the OS is executed by the processor 801.

While executing at least the part of the OS, the processor 801 executes the program that implements the function of the inter-data relation estimation section A-01.

By the processor 801 executing the OS, a task management, a memory management, a file management, a communication control, and the like are performed.

Further, at least one of information, data, a signal value, and a variable value indicating a result of the process of the inter-data relation estimation section A-01 is stored in at least one of the external storage device 802, the main storage device 803, and a register and a cache memory in the processor 801.

Further, the program that implements the function of the inter-data relation estimation section A-01 may be stored in a portable storage medium such as a magnetic disk, a flexible disk, an optical disk, a compact disk, a Blu-ray (registered trademark) disk, or a DVD.

The backup device 30 according to the present embodiment is a computer.

The backup device 30 includes a processor 301, an external storage device 302, a main storage device 303, and a communication device 304 as hardware.

The external storage device 302 stores a program that implements functions of the inter-data relation estimation result presentation section B-01, the inter-data relation acquisition section B-02, the division pattern acquisition section B-03, and the backup execution section B-04.

The program that implements the functions of the inter-data relation estimation result presentation section B-01, the inter-data relation acquisition section B-02, the division pattern acquisition section B-03, and the backup execution section B-04 is loaded from the external storage device 302 into the main storage device 303, and is executed by the processor 301.

FIG. 15 schematically illustrates a state in which the processor 301 executes the program that implements the functions of the inter-data relation estimation result presentation section B-01, the inter-data relation acquisition section B-02, the division pattern acquisition section B-03, and the backup execution section B-04.

The processor 301 is an IC that performs processing.

The processor 301 is, for example, a CPU or a DSP.

The external storage device 302 is, for example, a ROM, a flash memory, or an HDD.

The main storage device 303 is, for example, a RAM.

The communication device 304 illustrated in FIG. 15 is an electronic circuit that executes a data communication process.

The communication device 304 is, for example, a communication chip or an NIC.

An OS is also stored in the external storage device 302.

In addition, at least a part of the OS is executed by the processor 301.

While executing at least the part of the OS, the processor 301 execute the program that implements the functions of the inter-data relation estimation result presentation section B-01, the inter-data relation acquisition section B-02, the division pattern acquisition section B-03, and the backup execution section B-04.

By the processor 301 executes the OS, a task management, a memory management, a file management, a communication control, and the like are performed.

Further, at least one of information, data, a signal value, and a variable value indicating results of the processes of the inter-data relation estimation result presentation section B-01, the inter-data relation acquisition section B-02, the division pattern acquisition section B-03, and the backup execution section B-04 is stored in at least one of the external storage device 302, the main storage device 303, and a register and a cache memory in the processor 301.

Further, the program that implements the functions of the inter-data relation estimation result presentation section B-01, the inter-data relation acquisition section B-02, the division pattern acquisition section B-03, and the backup execution section B-04 may be stored in a portable storage medium such as a magnetic disk, a flexible disk, an optical disc, a compact disc, a Blu-ray (registered trademark) disc, or a DVD.

The restore test device 40 according to the present embodiment is a computer.

The restore test device 40 includes a processor 401, an external storage device 402, a main storage device 403, and a communication device 404 as hardware.

The external storage device 402 stores a program that implements functions of the restore test parameter acquisition section C-01, the inter-data relation acquisition section C-02, the restore test plan generation section C-03, and the restore test plan execution determination section C-04.

The program that implements the functions of the restore test parameter acquisition section C-01, the inter-data relation acquisition section C-02, the restore test plan generation section C-03, and the restore test plan execution determination section C-04 is loaded from the external storage device 402 into the main storage device 403, and is executed by the processor 401.

FIG. 16 schematically illustrates a state in which the processor 401 executes the program that implements the functions of the restore test parameter acquisition section C-01, the inter-data relation acquisition section C-02, the restore test plan generation section C-03, and the restore test plan execution determination section C-04.

The processor 401 is an IC that performs processing.

The processor 401 is, for example, a CPU or a DSP.

The external storage device 402 is, for example, a ROM, a flash memory, or an HDD.

The main storage device 403 is, for example, a RAM.

The communication device 404 illustrated in FIG. 16 is an electronic circuit that executes a data communication process.

The communication device 404 is, for example, a communication chip or an NIC.

An OS is also stored in the external storage device 402.

In addition, at least a part of the OS is executed by the processor 401.

While executing at least the part of the OS, the processor 401 executes the program that implements the functions of the restore test parameter acquisition section C-01, the inter-data relation acquisition section C-02, the restore test plan generation section C-03, and the restore test plan execution determination section C-04.

By the processor 401 executing the OS, a task management, a memory management, a file management, a communication control, and the like are performed.

Further, at least one of information, data, a signal value, and a variable value indicating results of the processes of the restore test parameter acquisition section C-01, the inter-data relation acquisition section C-02, the restore test plan generation section C-03, and the restore test plan execution determination section C-04 is stored in at least one of the external storage device 402, the main storage device 403, and a register and a cache memory in the processor 401.

Further, the program that implements the functions of the restore test parameter acquisition section C-01, the inter-data relation acquisition section C-02, the restore test plan generation section C-03, and the restore test plan execution determination section C-04 may be stored in a portable storage medium such as a magnetic disk, a flexible disc, an optical disc, a compact disc, a Blu-ray (registered trademark) disc, or a DVD.

Besides, in the present embodiment, the inter-data relation estimation device 80, the backup device 30, and the restore test device 40 are assumed to be configured by different computers. However, the inter-data relation estimation device 80, the backup device 30, and the restore test device 40 may be configured by a same computer.

Further, “section” of the inter-data relation estimation section A-01, the inter-data relation estimation result presentation section B-01, the inter-data relation acquisition section B-02, the division pattern acquisition section B-03, the backup execution section B-04, the restore test parameter acquisition section C-01, the inter-data relation acquisition section C-02, the restore test plan generation section C-03, and the restore test plan execution determination section C-04 may be read as “circuit” or “step” or “procedure” or “process”.

Further, each of the inter-data relation estimation device 80, the backup device 30, and the restore test device 40 may be implemented by a processing circuit. The processing circuit is, for example, a logic IC (Integrated Circuit), a GA (Gate Array), an ASIC (Application Specific Integrated Circuit), or an FPGA (Field-Programmable Gate Array).

In the present specification, a superordinate concept of the processor and the processing circuit is referred to as “processing circuitry”.

That is, each of the processor and the processing circuit is a specific example of the “processing circuitry”.

### REFERENCE SIGNS LIST

1: restore test execution system, 10: actual environment device, 20: information storage device, 30: backup device, 40: restore test device, 50: backup storage, 60: restore test storage, 70: user terminal, 80: inter-data relation estimation device, 100: data processing device, A-01: inter-data relation estimation section, B-01: inter-data relation estimation result presentation section, B-02: inter-data relation acquisition section, B-03: division pattern acquisition section, B-04: backup execution section, C-01: restore test parameter acquisition section, C-02: inter-data relation acquisition section, C-03: restore test plan generation section, C-04: restore test plan execution determination section, C-05: restore test execution section, D-01: inter-data relation information, D-02: test item list information, D-03: inter-data relation estimation result information, D-04: restore test execution result information, D-05: test divided data information, D-06: restore test parameter information.

1. A data processing device connected to a backup storage used for a backup of data and to a restore test storage used for a restore test on the data backed up, the data processing device comprising:
processing circuitry
to store in the backup storage, a plurality of pieces of test divided data selected as restore test targets from among a plurality of pieces of divided data divided from backup-targeted data in a smaller size than a storage size of the restore test storage; and
to repeat an operation of storing test divided data from the backup storage into the restore test storage and perform the restore test on the plurality of pieces of test divided data.

2. The data processing device according to claim 1,
wherein the processing circuitry estimates a relation between the plurality of pieces of divided data, and presents an estimation result to a user of the data processing device.

3. The data processing device according to claim 2,
wherein the processing circuitry monitors a usage status of the plurality of pieces of divided data in an actual environment in which the plurality of pieces of divided data are used, and estimates the relation between the plurality of pieces of divided data.

4. The data processing device according to claim 1,
wherein the processing circuitry acquires a relation between the plurality of pieces of divided data from a user of the data processing device.

5. The data processing device according to claim 2,
wherein the processing circuitry stores in the backup storage, the plurality of pieces of test divided data selected as the restore test targets by a user of the data processing device based on the relation between the plurality of pieces of divided data.

6. The data processing device according to claim 1,
wherein the processing circuitry selects based on a test execution time condition, a test coverage condition, and a size of each test divided data and a storage size of the restore test storage, a restore test pattern satisfying the test execution time condition and the test coverage condition from among a plurality of restore test patterns in which combinations of a test execution time and a test coverage are different, and performs the restore test on the plurality of pieces of test divided data according to the restore test pattern selected from among the plurality of restore test patterns.

7. A data processing method by a computer connected to a backup storage used for a backup of data and to a restore test storage used for a restore test on the data backed up, the data processing method comprising:
storing, by the computer, in the backup storage, a plurality of pieces of test divided data selected as restore test targets from among a plurality of pieces of divided data divided from backup-targeted data in a smaller size than a storage size of the restore test storage; and
repeating, by the computer, an operation of storing test divided data from the backup storage into the restore test storage and performing the restore test on the plurality of pieces of test divided data.

8. A non-transitory computer readable medium storing a data processing program which causes a computer connected to a backup storage used for a backup of data and to a restore test storage used for a restore test on the data backed up, to execute:
a backup execution process of storing in the backup storage, a plurality of pieces of test divided data selected as restore test targets from among a plurality of pieces of divided data divided from backup-targeted data in a smaller size than a storage size of the restore test storage; and
a restore test execution process of repeating an operation of storing test divided data from the backup storage into the restore test storage and performing the restore test on the plurality of pieces of test divided data.

9. The data processing device according to claim 4,
wherein the processing circuitry stores in the backup storage, the plurality of pieces of test divided data selected as the restore test targets by a user of the data processing device based on the relation between the plurality of pieces of divided data.
